(19) United States
(12) Patent Application Publication
(10) Pub. No.: US 2009/0212092 A1
(43) Pub. Date: Aug. 27, 2009

(54) METHOD FOR FORMING FRICTION WELDED COMPRESSION BASED TUBULAR STRUCTURES

(76) Inventor: Israel Stol, Pittsburgh, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 12/035,223

(22) Filed: Feb. 21, 2008

(51) Int. Cl. B23K 20/12; F16L 9/22

(52) U.S. Cl. 228/112.1; 138/155

(57) ABSTRACT

A method of making a compression based tubular structure having at least one structural joint using the friction welding process to improve the durability of tubular structures and structural integrity via increased resistance to tension and fatigue type loading and resistance to corrosion. A method of making a compression based tubular structure having at least one structural joint using the friction welding process is provided. In addition, a compression based tubular structure is provided. The compression based tubular structure comprises at least one tubular structure joint, at least one pair of flanges that surround each tubular joint, and a plurality of tension rods that connect the pair of flanges that surround the tubular structure joint.

### BACKGROUND OF THE INVENTION

In one embodiment, the present invention relates to a method for making compression based tubular structures using friction welding. In another embodiment, the invention pertains to a method for making compression based tubular structures, such as risers for the oil-drilling industry, sleeves for cannons and any other compression based tubular structures that are friction welded. In a further embodiment, compression based tubular structures may consist of pipes/tubes that are joined end to end, pipe/tube to flange ends that are joined end to end and/or pipe/tube to hollow-end cap that are joined end to end by friction welding for use between a well platform and an oil well or gas well located on the sea floor.

When an oil well or a gas well located on the sea floor is drilled from a platform, steel pipes of a predetermined length are connected together, end to end to form a casing tube which is lowered from the platform to the sea floor. The casing tube forms a conduit between the platform and the gas or oil well on the sea floor beneath the platform. The casing tube is initially used when the well is being drilled and, thereafter, it is used to bring the crude oil or gas from the sea floor up to the platform. Since the oil well or gas well is located at the bottom of the sea which can be thousands of meters below the platform, the casing tube can have a length of thousands of meters.

In general, the casing tube used today extends from a platform to the sea floor is made of carbon steel pipes each having a predetermined length of about 10 to 15 meters and which are joined by any one of known methods such as a bolting joining method, a welding method. Because the casing tube which extends from the platform to the sea floor can have a length of thousands of meters, the carbon steel pipes of the casing tube near the surface of the sea and immediately below the platform must support the pull of the total weight of all the carbon steel pipes that are attached to it. In addition, the horizontal tidal flow of the water between the sea bottom and the platform subjects the casing tube to an additional pulling force. Thus, the pipes at and near the top of the casing tube are subjected to a very large pulling force.

In many instances, if no corrective measures are taken, this pulling force may be sufficient to stretch the carbon steel pipes near the top of the casing tube beyond their elastic limit and possibly lead to their catastrophic failure (e.g. rapture of seams, and joints such as welds).

Currently, to reduce the pulling force on the carbon steel pipes of the casing tube, floatation members, like buoyancy compensators, are attached to the carbon steel pipes of the casing tube. The flotation members are used to provide an upward force which helps to reduce the destructive down ward pull on the carbon steel tubes of the casing tube.

In one embodiment, the present invention discloses a method of making a compression based tubular structure using the friction welding process that provides very strong and reliable welds between the different segments of such structures (e.g. Risers), which in turn affords the use of thinner and lighter pipes. In another embodiment, the method of making a compression based tubular structure using friction welding to withstand the pulling force on the compression based tubular structure. In another embodiment, this method may be used to weld different alloys to each other.

### SUMMARY OF THE INVENTION

In one embodiment, the present invention provides a method for of making a compression based tubular structure using friction welding that improves the durability and structural integrity of tubular structures via increased resistance to tension and fatigue types of loading and in some cases resistance to corrosion. The method comprises machining square a first end and a second end of a first pipe, machining square a first end and a second end of a second pipe, friction welding the second end of the first pipe to the first end of the second pipe to create a joint, machining square the first end of the first pipe and the second end of the second pipe, machining square a flanged-end of a flange, friction welding the flanged-end of the flange to the first end of the first pipe to create a second joint, machining square the second end of the second pipe, machining square a flanged-end of a second flange, friction welding the flanged-end of the second flange to the second end of the second pipe to create a third joint, and connecting a plurality of tension rods between the flange and the opposite second flange where the compression based tubular structure has at least one structural joint using the friction welding process.

In another embodiment, the method comprises machining square a first end and a second end of a first pipe, machining square a first end and a second end of a flange, friction welding the first end of the first pipe to the second end of the flange to create a joint, machining square a first end and a second end of the second pipe, machining square a first end and a second end of a second flange, friction welding the second end of the second pipe to the first end of the second flange to create a second joint, machining square the second end of the first pipe, machining square the first end of the second pipe, machining square the first end of the flange, machining square the second end of the second flange, and friction welding the second end of the first pipe to the first end of the second pipe to create a third joint, and connecting a plurality of tension rods between the flange and the second flange, wherein the compression based tubular structure has at least one structural joint using the friction welding process.

In another embodiment, a rotational stop is used for aligning the orientation of the flanges. In a further embodiment, holes are drilled in the flanged-end of one of the flanges of the compression based tubular structure to align the orientation of both flanges.

In yet another embodiment, the compression based tubular structure is friction welded to at least one other compression based tubular structure.

In another embodiment, the tension rods are made of composite, fiberglass, or metal.

In another embodiment, the compression based tubular structure is encased in a buoyancy-compensator.

In yet a further embodiment, the present invention discloses a compression based tubular structure comprising at least one tubular structure joint, at least one pair of flanges that surrounding each tubular joint, and a plurality of tension rods that connect the pair of flanges that surround the tubular structure joint.

Accordingly, it is one embodiment of the invention to provide a method for making compression based tubular structures using friction welding that create highly reliable and consistent weld quality and great performance with decreased weight load by using thinner pipes.

It is another embodiment of the invention to provide a method for making compression based tubular structures by welding various different alloys to each other.

These and other further embodiments of the invention will become more apparent through the following description and drawing.

### BRIEF DESCRIPTION OF THE DRAWINGS

For a fuller understanding of the invention, reference is made to the following description taken in connection with the accompanying drawing(s), in which:

FIG. 1 is a perspective view of a tubular structure pre-stressed to be in compression in accordance with the invention;

FIG. 2 is a sectional view showing a flange and the end of a pipe prior to the flange being friction welded to the pipe;

FIG. 3 is a sectional view of two sections of a pipe being friction welded together to form a single pipe having a desired length;

FIG. 4 is a side view of a plurality of pre-stressed pipes assembled to form a tubular structure/casing tube;

FIG. 5 is a side sectional view of two flanges of the ends of two pre-stressed pipes of a casing tube coupled together;

FIG. 6 is an end view of a flange showing the various apertures contained therein;

FIG. 7 is a perspective view of a compression based tubular structure in accordance with another embodiment of the present invention;

FIG. 8A is a side view of the compression based tubular structure where a flange is integral with one end of this structure;

FIG. 8B is an exploded view of a compression based tubular of FIG. 8A;

FIG. 9 is an end view of another type of flange showing the various apertures contained therein in accordance with another embodiment of the present invention;

FIG. 10 is a cross-sectional view of the tension rod connected to the flange; and

FIG. 11 is a perspective view of a compression based tubular structure that is encased in a buoyancy compensator in accordance with the present invention.

### DETAILED DESCRIPTION OF THE PREFERRED EMBODIMENTS

The present invention discloses a method for making compression based tubular structures using friction welding that results in improving the reliability of welds, corrosion resistance and decreasing the weight load of a tubular structure. The method of making the compression based tubular structure comprises machining square a first end and a second end of a first pipe, machining square a first end and a second end of a second pipe, friction welding the second end of the first pipe to the first end of the second pipe to create a joint, machining square the first end of the first pipe and the second end of the second pipe, machining square a flanged-end of a flange, friction welding the flanged-end of the flange to the first end of the first pipe to create a second joint, machining square the second end of the second pipe, machining square a flanged-end of a second flange, friction welding the flanged-end of the second flange to the second end of the second pipe to create a third joint, and connecting a plurality of tension rods between the flange and the second flange, where the compression based tubular structure has at least one structural joint using the friction welding process.

In another embodiment, the method comprises machining square a first end and a second end of a first pipe, machining square a first end and a second end of a flange, friction welding the first end of the first pipe to the second end of the flange to create a joint, machining square a first end and a second end of the second pipe, machining square a first end and a second end of a second flange, friction welding the second end of the second pipe to the first end of the second flange to create a second joint, machining square the second end of the first pipe, machining square the first end of the second pipe, machining square the first end of the flange, machining square the second end of the second flange, and friction welding the second end of the first pipe to the first end of the second pipe to create a third joint, and connecting a plurality of tension rods between the flange and the second flange, where the compression based tubular structure has at least one structural joint using the friction welding process.

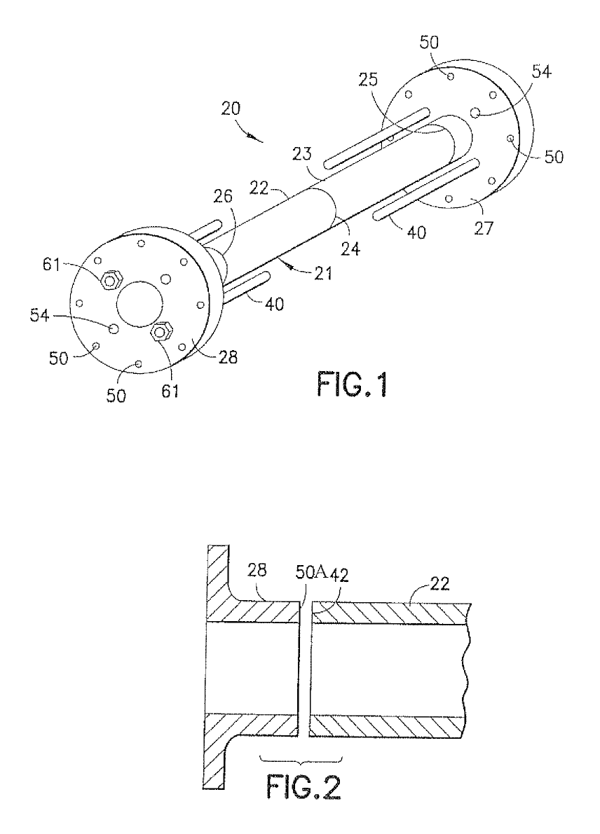

FIG. 1 shows a perspective view of a tubular structure pre-stressed to be in compression by externally located rods that are in tension. More specifically, a compression based tubular structure 20 is made up of a pipe 21 which can have two pipe sections 22, 23 joined together at a central located weld or weld seam 24 by friction welding. The ends 25, 26 of the pipe sections 22, 23 of the pipe 21 are joined by friction welding to flanges 27, 28. The pipe sections 22, 23 of the pipe 21 and the flanges 27, 28 can be of the same material and alloy or they may be of different materials or different alloys.

Suitable types of materials for the pipes and flanges that may be used in the present invention include, but are not limited to, aluminum, steel, titanium and/or combinations thereof. For example, the pipe sections can be of aluminum and the flanges can be of aluminum. In the alternative, the pipe sections can be composed of aluminum and the flanges can be composed of steel. The pipe and flange sections may also be composed of a composite such as fiberglass.

FIG. 1 shows that each flange 27, 28 has a plurality of various apertures for different purposes where the various apertures in flange 27 are aligned with cooperating apertures in flange 28. For example, where pipe 21 has two rods which are used to pre-stress the pipe, each flange will have four alternately spaced apertures where two of the four apertures are sized to receive threaded tension rods and the other two of the four apertures are clearance openings for nuts that are threaded onto the threaded tension rods. In addition, each flange will have four or more apertures located inboard, outboard or on the same circumference as the four apertures for receiving threaded bolts and nuts for clamping the flanges of two pipes together.

Pipe 21 can consist of a number of individual sections joined together by friction welding. For example, pipe 21 can be a single section, or it can be made from two or more sections joined together by friction welding. The flanges at the ends of the pipe 21 can be separate flanges which are friction welded to the ends of the pipe 21. In the embodiment where the pipe 21 is made up of two pipe sections 22, 23, the two sections 22, 23 can be joined together by friction welding, and a flange can then be attached to each end of pipe 21 by friction welding. It is understood that the order of friction welding the various parts to each other is not critical and in one embodiment the two pipe sections 22, 23 are first friction welded to each other, and the flanges 27, 28 are then friction welded to the ends of the pipe 21. In another embodiment, pipe sections 22, 23 are first friction welded to flange 28, 27, respectively. Then, the two pipe sections-flange components are friction welded to each other to create the tubular structure.

The ends of the parts to be friction welded are first machined square for cleanliness so that they are nearly perfectly parallel to each other and perpendicular to the neutral axis of the pipes being friction welded and the axis of friction welding.

FIG. 2 shows a sectional view of a flange and the end of a pipe prior to the flange being friction welded to the pipe.

FIG. 3 shows a sectional view of two sections of a pipe being friction welded together to form a single pipe having a desired length. Pipe section 22 has a first end 32 and a second end 33. Pipe section 23 has a first end 34 and a second end 35. The first end 32 of pipe section 22 is butted against a stop member 43 which prevents pipe section 22 from moving to the left, when the axial forging force is applied during the friction welding operation. Positioned around the outside surface of pipe section 22 are locating clamps 43 which function to both accurately locate pipe section 22 so its neutral axis is parallel to the axis of rotation of the other pipe, 23, during the friction welding operations and to securely clamp pipe section 22 to prevent it from rotating. It is noted that each end of pipe section 22 is machined to be square and free of thick surface oxides (e.g. aluminum oxide, rust), grease and other impurities. Pipe section 23 is positioned to the right of pipe section 22 and is aligned with pipe section 22 such that second end 33 of pipe section 22 and first end 34 of pipe section 23 are aligned with and nearly parallel with each other. Locating clamps 44 are provided to both accurately position and align pipe section 23 with its neutral axis and axis of rotation during friction welding and with pipe section 22 and to firmly clamp section 23 so it can be rotated (spun) by the friction welding machine. Locating clamps 44 are coupled to a rotating member 46 which, in turn, is coupled to a torque motor or a flywheel coupled to rotatably drive the clamps and pipe section 23. A piston 47 positioned to push the pipe section 23 toward the left is located at the second end 35 of pipe section 23. Alternatively, the more conventional approach is to incorporate both the mechanism that holds, deploys and retracts clamps 44 and the system 47 to axially push pipe section 23, towards section 22, with the rotating member 46. Prior to positioning pipe section 23 in the locating clamps 44 at the right of pipe section 22, both ends of pipe section 23 are machined to be square and free of thick oxides, grease and other impurities. In operation, pipe section 23 is rotated by the torque motor or flywheel as second end 33 of pipe section 22 and first end 34 of pipe sections 23 are forced toward each other by the piston 47 until the ends of the pipe sections friction weld together to form weld seam 24 as shown in FIG. 1.

Each end of the pipe 21 is now in condition to be friction welded to a flange. When friction welding a flange to an end of pipe 21, pipe 21 is clamped in a fixed position and the flange is advanced toward and contacts the end of the pipe 21 as it is rotated relative to the pipe 21. Thereafter, the pipe 21 is turned around, is fixed in position and the second flange is moved into contact with the end of the pipe as it is rotated to friction weld the other end of the pipe 21 to the flange. When friction welding the second flange to the pipe 21, an indexing member is used to align the apertures in the first flange friction welded to the pipe section 21 with cooperating aperture in the second flange being friction welded to the pipe section 21, while a rotational stop is used on the already friction welded subassembly.

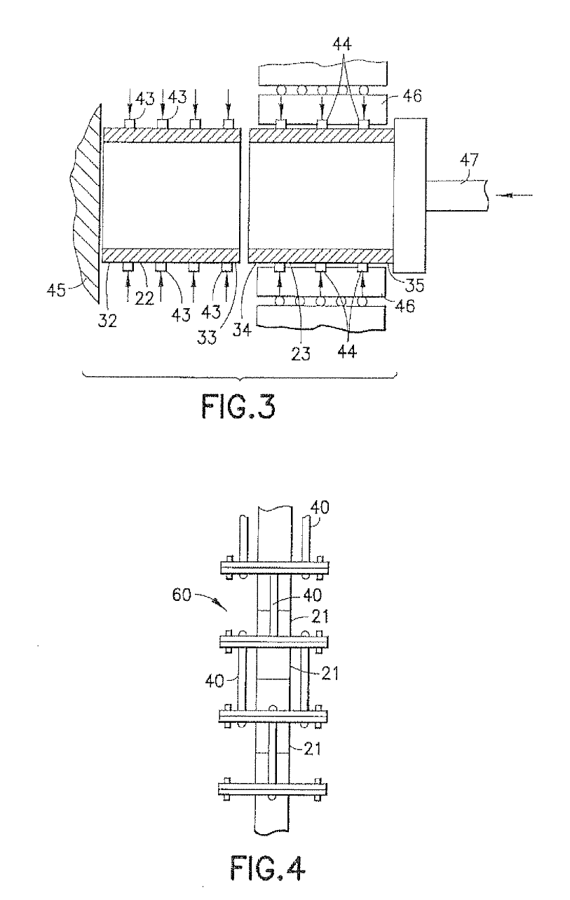

FIG. 4 shows a side view of a plurality of compression based tubular structures assembled to form a casing tube.

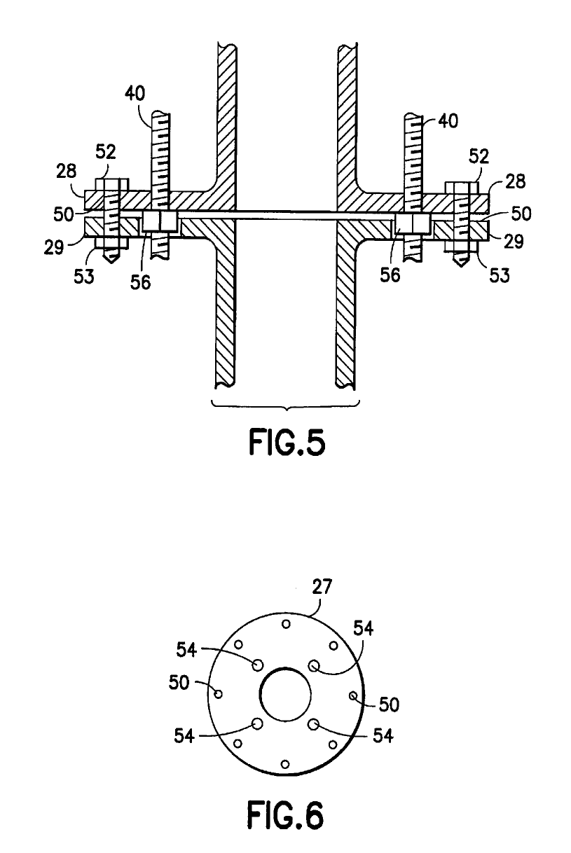

A side sectional view of the flanges on the ends of two compression based pipes clamped together to form a water tight connection is shown in FIG. 5. In this embodiment, the flanges are designed to receive two tension rods 40.

Referring to FIGS. 5 and 6, flange 27 has a plurality of apertures. One group of eight apertures 50 are used for receiving eight threaded bolts 52 and nuts 53. The bolts 52 and nuts 53 are used to tightly clamp the flanges 28, 29 together to provide a solid and water proof connection. Prior to welding the flanges to the pipe, the flanges were machined flat to help provide a water tight seal between the flanges. If desired, a gasket or sealing compound (not shown) can be located between the flanges to insure that the space between the two flanges 28, 29 is water tight. In this embodiment, flange 28 is designed to receive four tension rods 40. Therefore, flange 28 has four apertures 54, each having a diameter slightly larger than the diameter of the rods 40, each having a diameter sufficient to freely accept a nut 56 that is attached to the end of a rod 40 of an adjacent pipe 21. It is understood that the apertures 54 are located on the same circle and that apertures 50 can be located inboard, out board or on the same circle as apertures 54. In addition, the number of apertures in the flanges for the rods 40 and for the bolts 52 are not fixed. Typically the compression of the tubes will be achieved by three or more tension rods 40

After the flanges have been friction welded to the pipe 21, rods 40, which are threaded at each end, are then inserted into aligned apertures 54 in the flanges 28, 29. The ends of the rods extend through the apertures 54 and a nut 61 (see FIG. 1 ) is threaded onto each end of the rod 40. One or both of the nuts are then tightened until the rods are stretched at an amount sufficient to pre-stress the pipe 21 by placing it in compression. Thus, by tensioning the rods and placing them in tension, the pipe 21 is pre-stressed and is placed in compression.

Referring to FIG. 4, there is shown a side view of a number of pipes 21 assembled end to end to form a section of a casing tube 60. In FIG. 4, each pipe 21 has two rods 40 used to pre-stress the pipe 21. In is understood that the pipes 21 at the top of a casing tube can have three or four or more rods 40 where the forces are the greatest, and the pipes 21 at the bottom of the casing tube can have fewer rods because the forces are less.

By making each of the pipes of a light weight material such as aluminum, and by pre-stressing each of the pipes 21 to be in compression, a casing tube formed by attaching a plurality of the tubes 21 together end to end can be made which can have a length of thousands of meters for use between a platform and the bottom of the sea which does not require flotation means.

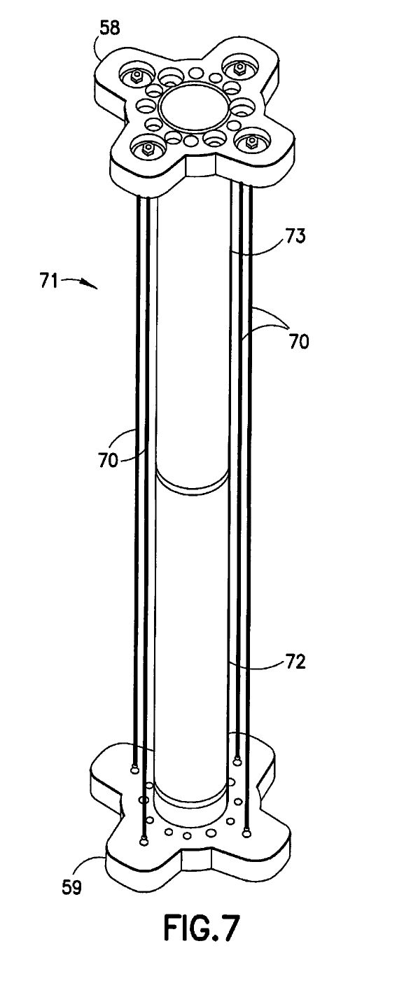

FIG. 7 shows a perspective view of a compression based tubular structure in accordance with another embodiment of the present invention. Here, flanges 58, 59 have four ears. This allows the connection of a plurality of tension rods 70 without taking up the space needed for the holes into or through the existing utility lines, such as compressed air, hydraulic, etc.

In general, tension rods are made of a material that will be sized and connected to the flanges by mechanical means, in a manner that will permit their repeated flexing and stretching with the tubular structure without yielding and chaffing. Suitable types of tension rods that may be used in the present invention include, but are not limited to, composite, glass fibers, or steel and/or combinations thereof. Each tension rod may also be made of bundles or multiple rods.

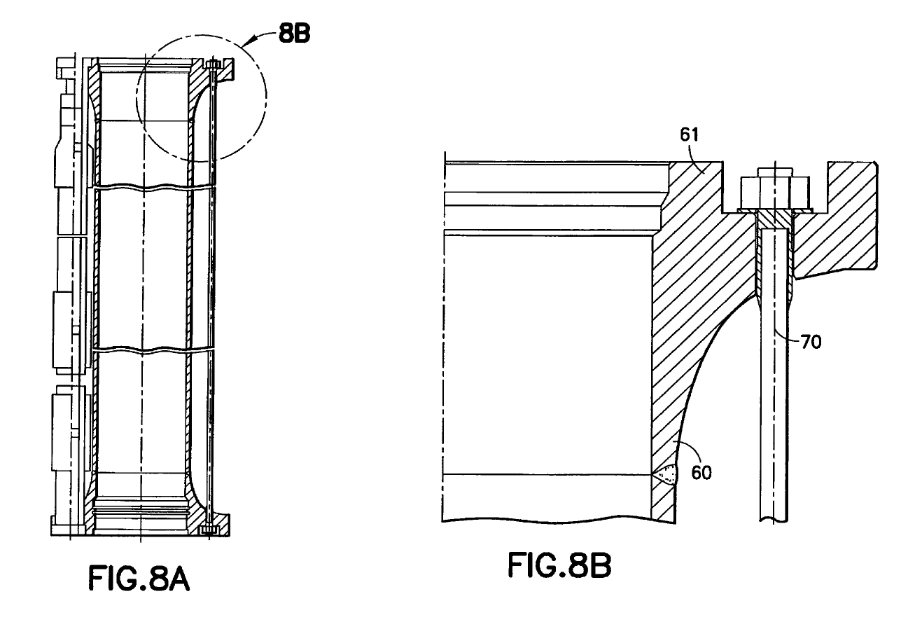

FIG. 8A shows a side view of the compression based tubular structure where a flange 60 is integral with an end flange 61. FIG. 8B shows an exploded view of flange 60.

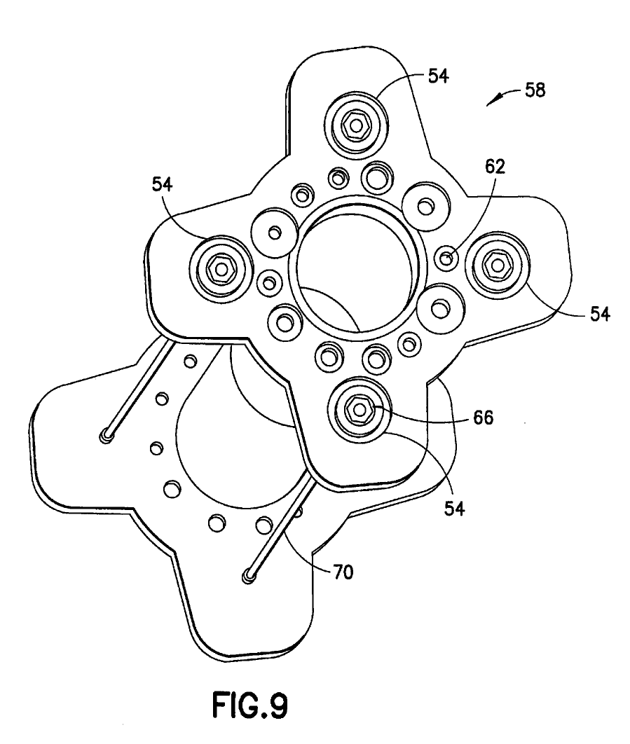

FIG. 9 shows an end view of another type of flange that may be used in the present invention. Here, flange 58 has four ears with a plurality of apertures. One group of eight apertures 62 are used for receiving eight threaded bolts and nuts (not shown). In this embodiment, flange 58 is designed to receive four rods 70. Therefore, flange 58 has four apertures 54, each having a diameter slightly larger than the diameter of the rods 70 each having a diameter sufficient to freely accept a nut 66 that is attached to the end of a rod 70 of an adjacent pipe 72 as shown in FIG. 7. It is understood that the apertures 54 are located on the ears of flange 58 and that apertures 62 can be located inboard from apertures 54. In addition, the number of apertures in the flanges for the rods 70 and for the bolts is not fixed.

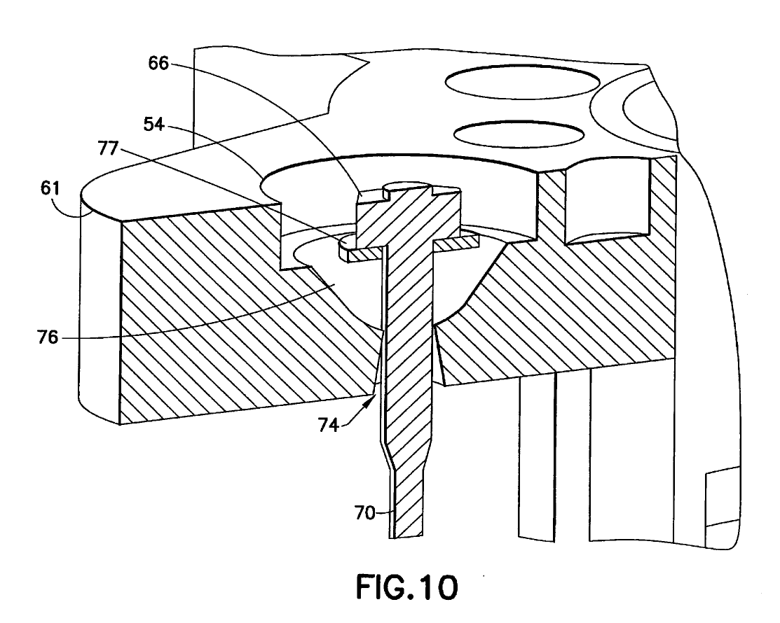

FIG. 10 shows a cross-sectional view of the tension rod connected to flange 60. Tension rod 70 is connected to end flange 61 through aperture 54 with a washer 77 and a self-locking nut 66. Aperture 54 has a swivel opening 76 for nut 66 to allow for flexing of tension rod 70. There is a flared opening 74 opposite swivel opening 76 in aperture 54 to allow flexing and prevent chaffing of the tension rod 70.

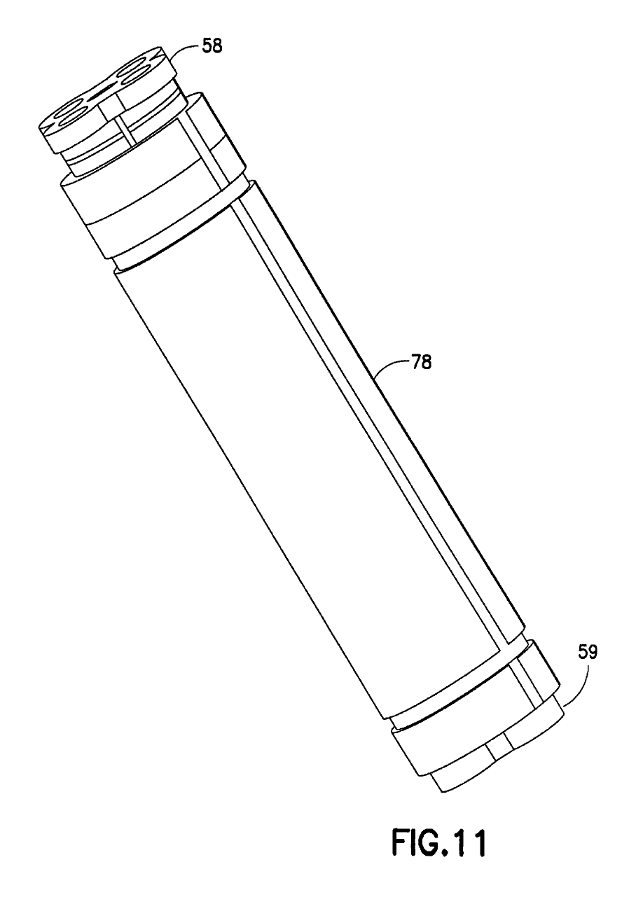

In another embodiment of the present invention, to protect tension rods from the environment, such as the sea, they are encased by a buoyancy-compensator 78 as shown in FIG. 11.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

1. A method of making a compression based tubular structure comprising the steps of:
machining square a first end and a second end of a first pipe;
machining square a first end and a second end of a second pipe;
friction welding the second end of the first pipe to the first end of the second pipe to create a first friction stir welded joint;
machining square the first end of the first pipe and the second end of the second pipe;
machining square a flanged-end of a first flange;
friction welding the flanged-end of the first flange to the first end of the first pipe to create a second friction stir welded joint;
machining square the second end of the second pipe;
machining square a flanged-end of a second flange;
friction welding the flanged-end of the second flange to the second end of the second pipe to create a third friction stir welded joint;
connecting a plurality of tension rods between the first flange and the second flange; and
stretching the plurality of tension rods during assembly to place in compression the first pipe, the second pipe, and the first stir welded joint therebetween.

2. The method of claim 1, further comprising the step of aligning the orientation of the flanged-end of the flange and the flanged-end of the second flange.

3. The method of claim 1, further comprising the step of drilling holes in the flanged-end of the second flange of the compression based tubular structure to align the orientation of the flanged-end of the flange and the flanged-end of second flange.

4. The method of claim 1, further comprising the step of friction welding the compression based tubular structure to at least one other compression on based tubular structure.

5. The method of claim 1, wherein the plurality of tension rods are made of composite.

6. The method of claim 1, wherein the plurality of tension rods are made of fiberglass.

7. The method of claim 1, wherein the plurality of tension rods are made of metal.

8. The method of claim 1, further comprising the step of encasing the compression based tubular structure in a buoyancy-compensators.

9. A method of making a compression based tubular structure comprising the steps of:
machining square a first end and a second end of a first pipe;
machining square a first end and a second end of a first flange;
friction welding the first end of the first pipe to the second end of the first flange to create a first friction stir welded joint;
machining square a first end and a second end of the second pipe;
machining square a first end and a second end of a second flange;
friction welding the second end of the second pipe to the first end of the second flange to create a second friction stir welded joint;
machining square the second end of the first pipe;
machining square the first end of the second pipe;
machining square the first end of the first flange;
machining square the second end of the second flange; and
friction welding the second end of the first pipe to the first end of the second pipe to create a third friction stir welded joint; and
connecting a plurality of tension rods between the first flange and the second flange; and
stretching the plurality of tension rods during assembly to place in compression the first pipe, the second pipe, and the first stir welded joint therebetween.

10. The method of claim 9, further comprising the step of aligning the orientation of the flange and the second flange.

11. The method of claim 9, further comprising the step of drilling holes in the second flanged of the tubular structure to align the orientation of the first flange and the second flange.

12. The method of claim 9, further comprising the step of friction welding to weld the compression based tubular structure to at least one other compression based tubular structure.

13. The method of claim 9, wherein the tension rods are made of composite.

14. The method of claim 9, wherein the tension rods are made of fiberglass.

15. The method of claim 9, wherein the tension rods are made of metal.

16. The method of claim 9, further comprising the step of encasing the compression based tubular structure in a buoyancy-compensators.

17. A compression based tubular structure comprising:
two pre-stressed pipe sections;
a joint joining the two pre-stressed pipe sections at adjacent ends thereto;
a pair of monolithic flange/pipes joined to each opposing end of the two pre-stressed pipe sections; and
a plurality of stretched tension rods connected between the pair of monolithic flange/pipes to place in compression the two pre-stressed pipe sections and the friction stir welded joint therebetween.

18. The compression based tubular structure of claim 17, wherein the compression based tubular structure is encased in a buoyancy-compensator.

19. The compression based tubular structure of claim 17, the joint is a friction stir weldment.

20. The compression based tubular structure of claim 17, wherein the two pre-stress pipe sections are approximately of equal length.

21. The compression based tubular structure of claim 17, further comprising a third pre-stressed section joined between the two pre-stressed pipe sections.

22. The compression based tubular structure of claim 17, wherein each monolithic flange/pipe of the pair of monolithic flange/pipes comprises an aperture sized to receive there through one tension rod of the plurality of tension rods, wherein the aperture comprises (i) an outwardly parabolic-shaped swivel opening to receive a nut connected to an end of the one tension rod, and (ii) an outwardly flared opening opposing the outwardly parabolic-shaped swivel opening, whereby spaces are formed on either side of the aperture for the one tension rod to flex without contacting a side of the aperture.
